(19) United States
(12) Patent Application Publication
(10) Pub. No.: US 2014/0279831 A1
(43) Pub. Date: Sep. 18, 2014

(54) DATA MODELING TECHNIQUES

(71) Applicant: Teradata US, Inc., Dayton, OH (US)

(72) Inventors: Thomas Kevin Ryan, Valley Center, CA (US); Anand Louis, Bangalore (IN)

(73) Assignee: Teradata US, Inc., Dayton, OH (US)

(21) Appl. No.: 14/039,197

(22) Filed: Sep. 27, 2013

Related U.S. Application Data
(60) Provisional application No. 61/788,607, filed on Mar. 15, 2013.

(51) Int. Cl. G06F 17/30

(52) U.S. Cl. CPC G06F 17/30563
USPC 707/602

(57) ABSTRACT

Techniques for data modeling are provided. Enterprise data is organized into reference data for entities that an enterprise wants to track and monitor. Relationship data is created that establishes relationships among the various entities within the enterprise data. The reference data and the relationship data are published within an enterprise data warehouse for accessing the enterprise data.

### RELATED APPLICATIONS

The present application is co-pending with, claims priority to, and is a non-provisional application of Provisional Application No. 61/788,607 entitled: “Techniques for Collecting and Managing Data,” filed on Mar. 15, 2013; the disclosure of which is hereby incorporated by reference in its entirety herein and below.

### BACKGROUND

After over two-decades of electronic data automation and the improved ability for capturing data from a variety of communication channels and media, even small enterprises find that the enterprise is processing terabytes of data with regularity. Moreover, mining, analysis, and processing of that data have become extremely complex. The average consumer expects electronic transactions to occur flawlessly and with near instant speed. The enterprise that cannot meet expectations of the consumer is quickly out of business in today's highly competitive environment.

Consumers have a plethora of choices for nearly every product and service, and enterprises can be created and up-and-running in the industry in mere days. The competition and the expectations are breathtaking from what existed just a few short years ago.

As a result, the most important asset of the enterprise has become its data. That is, information gathered about the enterprise's customers, competitors, products, services, financials, business processes, business assets, personnel, service providers, transactions, and the like.

Updating, mining, analyzing, reporting, and accessing the enterprise information can still become problematic because of the sheer volume of this information and because often the information is dispersed over a variety of different file systems, databases, and applications. In fact, the data and processing can be geographically dispersed over the entire globe. When processing against the data, communication may need to reach each node or communication may entail select nodes that are dispersed over the network.

A major dependency on providing an integrated data view with comprehensive data access, is the underlying data model for the data. A poor data model can cause a tremendous amount of additional work and expense for an enterprise to just provide a mediocre data service to its customers and its employees.

### SUMMARY

In various embodiments, techniques for data modeling are presented. According to an embodiment, a method for creating a data model within a data warehouse is provided.

Specifically, enterprise data is organized into reference data for entities being tracked by an enterprise. Next, relationship data is created that creates relationships among the entities within the reference data. Finally, the reference data and the relationship data are made available via one or more interfaces to access the enterprise data.

### BRIEF DESCRIPTION OF THE DRAWINGS

FIG. 1 is a diagram of a method for creating a data model within a data warehouse, according to an example embodiment.

FIG. 2 is a diagram of a method for creating a record instance within the data model of the FIG. 1, according to an example embodiment.

FIG. 3 is a diagram of a data modeling system, according to an example embodiment.

### DETAILED DESCRIPTION

FIG. 1 is a diagram of a method 100 for creating a data model within a data warehouse, according to an example embodiment. The method 100 (hereinafter “data modeler”) is implemented as executable instructions that are programmed and reside within memory and/or non-transitory computer-readable storage media for execution on one or more processing nodes (processor(s)) of a network; the network wired, wireless, and/or a combination of wired and wireless.

Initially, it is noted that specific embodiments and sample implementations for various aspects of the invention are provided in detail in the provisional filing (Provisional Application No. 61/788,607), which is incorporated by reference in its entirety herein.

As used herein, “an entity” is an logical piece of information that an enterprise wants to track and/or monitor. So, an entity can represent a customer, an account, and the like. Moreover, it is noted that “an entity” can be a customized grouping of multiple entities.

Enterprise data is data that is collected, indexed, and housed by an enterprise for purposes of analysis and providing services to internal and external customers.

It is within this initial and brief context, that the processing of the data modeler is now discussed with reference to the FIG. 1.

At 110, the data modeler organizes enterprise data into reference data for entities being tracked and/or monitored by an enterprise. The reference data may include key data or data that permits looking up and finding specific entities, specific entity types, and/or collections of entities/entity types.

According to an embodiment, at 111, the data modeler defines the reference data as records of data. Each record defining a party that is a specific type of entity. Some sample parties for an enterprise may include: an associate, an account, a business, a customer, a household, an individual, and an organization.

Continuing with the embodiment of 111 and at 112, the data modeler permits each party to be associated with one or more sub-party records. Each sub-party record defines a specific persona of a specific party. In other words, each instance of a party can have different mechanisms for identifying or describing some aspect of that party and these aspects may be referred to as personas.

In an embodiment, at 113, the data modeler populates each entity with a predefined set of attributes for an entity type associated with that entity. So, each entity type can include a predefined attribute, such as address. There can be a set of address attributes, such as mail addresses, social media addresses, telephone addresses, home addresses, email addresses, and the like.

Continuing with the embodiment of 113 and at 114, the data modeler permits each entity to create custom attributes specific to that entity. So, any customization can occur that is desired for each entity.

At 120, the data modeler creates relationship data that creates relationships among the entities within the reference data. This is associations or linkages created within the enterprise data among the entities. Some relationships can be for one entity to another entity; groups of entities to a specific entity; a specific entity to groups of entities, or groups of entities to groups of entities. Some relationships for some entities can be predefined and automatically assigned whereas other relationships for some entities can be customized based on specific needs of an enterprise. The relationship can be implemented as a link and/or key that is tied to each of the entities.

According to an embodiment, at 121, the data modeler populates each relationship with a predefined set of attributes for a relationship type associated with that relationship.

Continuing with the embodiment of 121 and at 122, the data modeler permits each relationship to create custom attributes specific to that relationship.

At 130, the data modeler makes the reference data and the relationship data available via one or more interfaces to access the enterprise data. The reference data for master data into the enterprise data and includes the integrated relationship data. Together the organization of the reference data with the relationship data forms a new and novel data model for an enterprise that permits more detailed analysis and associations within the enterprise data of that enterprise.

In an embodiment, at 131, the data modeler publishes the reference data and the relationship data for access within a data warehouse. So, existing and legacy database or data warehouse tools can access the reference and relationship data to access (for whatever reason) the enterprise data.

According to an embodiment, at 140, the data modeler integrates the reference data and the relationship data into enterprise workflows. So, workflows can reference components of the reference data and utilize resulting information that the reference and/or relationship data provides from the enterprise data.

In another case, at 150, the data modeler develops a schema to represent the reference and relationship data. So, an single defined schema can define and drive the format and contents of the reference and relationship data for an enterprise.

In yet another situation, at 160, the data modeler logically represents the reference data having the relationship data as a single golden record. That is, a single truth or master representation for the reference data can be created that defines and provides access to all other aspects of the enterprise data.

In an embodiment, at 170, the data modeler integrates the research data and the relationship data into a parallel processing environment for a distributed relational database. So, the processor that processes the data modeler can actually be a series of processing nodes that cooperate with one another. In other words, different instances of the data modeler can execute within the same environment and cooperate with one another to improve efficiency in much the same way that a parallel distributed database works.

FIG. 2 is a diagram of a method 200 for creating a record instance within the data model of the FIG. 1, according to an example embodiment. The method 200 (hereinafter “data modeler instance manager”) is implemented as executable instructions within memory and/or non-transitory computer-readable storage media that execute on one or more processors (nodes), the processors specifically configured to data modeler instance manager. The data modeler instance manager is also operational over a network; the network is wired, wireless, or a combination of wired and wireless.

The data modeler instance manager presents a processing perspective from an interface (manual and controlled by a user and/or automated application that operates autonomously from any user) that populates a record of the data model presented above with respect to the FIG. 1.

At 210, the data modeler instance manager defines a specific party for a given party type. Again, the party is an entity that an enterprise is interested in tracking. The specific party can be selected based on the given party type and the party type can be predefined and available from a list for section or can be custom defined in some instances.

At 220, the data modeler instance manager associates a relationship between the specific party and another party. So, an association within enterprise data is being made between the instance of the specific party and another party. Again, the specific party or the other party for which the relationship is being created can each be groups of entities (or just one can be a group of entities).

At 230, the data modeler instance manager integrates the specific party and the relationship into a relational database as a golden record. That is, a single master record defining and providing independent access into enterprise data can be defined by a single “golden” (master) record.

According to an embodiment, at 231, the data modeler instance manager populates the specific party with multiple sub-parties that define personas for the specific party. This was described above with reference to the FIG. 1.

In an embodiment, at 240, the data modeler instance manager inherits predefined attributes for the specific party based on the given party type. In other words, a set of prepackaged enterprise attributes can be automatically supplied to the specific party instance based on its given party type.

Continuing with the embodiment of 240 and at 241, the data modeler instance manager inherits predefined relationship attributes for the relationship based on a relationship type and/or based on given party type and another party type associated with the other party of the relationship. So, multiple inheritance can occur from the party type and a relationship type.

Still continuing with the embodiment of 241 and at 242, the data modeler instance manager defines specific party attributes that are customized for an instance of the specific party being defined.

Similarly at 243, the data modeler instance manager defines specific relationship attributes that are customized for an instance of the relationship defined within the instance of the specific party being defined.

FIG. 3 is a diagram of a data modeling system 300, according to an example embodiment. The components of the data modeling system 300 are implemented as executable instructions that are programmed and reside within memory and/or non-transitory computer-readable storage medium that execute on one or more processing nodes (processors) of a network. The network is wired, wireless, or a combination of wired and wireless.

The data modeling system 300 implements, inter alia, the methods 100 and 200 of the FIGS. 1 and 2.

The data modeling system 300 includes a data modeler 301 and a data warehouse 302.

The data modeling system 300 includes a non-transitory computer-readable storage medium having executable instructions for the data modeler 301 that executes on one or more processors of the network. Example processing associated with the data modeler 301 was presented above with respect to the FIG. 1 and in some instances the FIG. 2.

The data modeler 301 is configured to organize enterprise data from the data warehouse 302 into reference data for entities being tracked by an enterprise and relationship data for relationships among the entities. The data modeler 301 is also configured to publish the reference data and the relationship data within the data warehouse 302.

The data warehouse 302 is implemented in memory and/or non-transitory computer-readable storage media that are accessible via the one or more processors. In an embodiment, the data warehouse 302 is a collection of storage environments logically accessible via one or more common interfaces.

The data warehouse 302 is configured to make the reference data and the relationship data available to interfaces of the data warehouse 302 to access the enterprise data.

According to an embodiment, the data warehouse 302 is a distributed parallel relational database.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented and programmed within a non-transitory computer-readable storage medium and processed by a processor, the processor configured to execute the method, comprising:
organizing, by the processor, enterprise data into reference data for entities being tracked by an enterprise;
creating, by the processor, relationship data that creates relationships among the entities within the reference data; and
making the reference data and the relationship data available via one or more interfaces to access the enterprise data.

2. The method of claim 1, wherein organizing further includes defining the reference data as records of data, each record defining a party that is a specific type of entity.

3. The method of claim 2, wherein defining further includes permitting each party to be associated with one or more sub-party records, each sub-party record defining a specific persona of a specific party.

4. The method of claim 1, wherein organizing further includes populating each entity with a predefined set of attributes for an entity type associated with that entity.

5. The method of claim 4, wherein populating further includes permitting each entity to create custom attributes specific to that entity.

6. The method of claim 1, wherein creating further includes populating each relationship with a predefined set of attributes for a relationship type associated with that relationship.

7. The method of claim 6, wherein creating further includes permitting each relationship to create custom attributes specific to that relationship.

8. The method of claim 1, wherein making further includes publishing the reference data and the relationship data for access within a data warehouse.

9. The method of claim 1 further comprising, integrating via the processor, the reference data and the relationship data into enterprise workflows.

10. The method of claim 1 further comprising, developing, via the processor, a schema to represent the reference data and the relationship data.

11. The method of claim 1 further comprising, logically representing, via the processor, the reference data having the relationship data as a single golden record.

12. The method of claim 1 further comprising, integrating, via the processor, the reference data and the relationship data into a parallel processing environment for a distributed relational database.

13. A method implemented and programmed within a non-transitory computer-readable storage medium and processed by a processor, the processor configured to execute the method, comprising:
defining, via the processor, a specific party for a given party type;
associating, via the processor, a relationship between the specific party and another party; and
integrating, via the processor, the specific party and the relationship into a relational database as a golden record.

14. The method of claim 13 further comprising, inheriting, via the processor, predefined attributes for the specific party based on the given party type.

15. The method of claim 14 further comprising, inheriting, via the processor, predefined relationship attributes for the relationship.

16. The method of claim 15 further comprising, defining, via the processor, specific party attributes customized for an instance of the specific party.

17. The method of claim 16 further comprising, defining, via the processor, specific relationship attributes customized for an instance of the relationship.

18. The method of claim 13 further comprising, populating, via the processor, the specific party with multiple sub-parties that define personas of the specific party.

19. A system, comprising:
a non-transitory computer-readable storage medium having instructions for a data modeler that execute on one or more processors of a network; and
a data warehouse implemented in memory and/or non transitory computer-readable storage media that is accessible via the one or more processors;
wherein the data modeler is configured to organize enterprise data from the data warehouse into reference data for entities being tracked by an enterprise and relationship data for relationships among the entities, the data modeler further configured to publish the reference data and the relationship data within the data warehouse, the data warehouse configured to make the reference data and the relationship data available via interfaces of the data warehouse to access the enterprise data.

20. The system of claim 19, wherein the data warehouse is a distributed parallel relational database.
